(19) United States
(12) Patent Application Publication
(10) Pub. No.: US 2015/0304942 A1
(43) Pub. Date: Oct. 22, 2015

(54) ACTIVE SCAN OVERHEAD REDUCTION

(71) Applicant: QUALCOMM Incorporated, San Diego, CA (US)

(72) Inventor: Maarten Menzo Wentink, Naarden (NL)

(21) Appl. No.: 14/681,987

(22) Filed: Apr. 8, 2015

Related U.S. Application Data
(60) Provisional application No. 61/980,237, filed on Apr. 16, 2014.

(51) Int. Cl. H04W 48/16; H04W 52/60; H04W 48/10

(52) U.S. Cl. CPC H04W 48/16; H04W 48/10; H04W 52/60

(57) ABSTRACT

Methods, systems, and devices are described for enhanced network utilization in a wireless communications network through efficient transmissions of active scan information between an access point (AP) and a station. An AP may receive a number of different probe requests from a number of different stations in the wireless communications network. The AP may group probe responses and provide a single probe response to multiple probe requests. The single probe response may be a broadcast probe response that may be received by a number of stations, or may be a unicast probe response for a particular station. In some examples, a data rate of the probe response may be determined based on a signal strength of the received probe request(s).

### CROSS REFERENCES

The present Application for Patent claims priority to U.S. Provisional Patent Application No. 61/980,237 by Wentink et al., entitled “Active Scan Overhead Reduction,” filed Apr. 16, 2014, assigned to the assignee hereof, and expressly incorporated by reference herein.

### BACKGROUND

1. Field of the Disclosure

The following relates generally to wireless communication, and more specifically to techniques for performing active scan in wireless communications networks with reduced overhead.

2. Description of the Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of the multiple-access systems include code-division multiple access (CDMA) systems, time-division multiple access (TDMA) systems, frequency-division multiple access (FDMA) systems, and orthogonal frequency-division multiple access (OFDMA) systems.

A wireless communications network may include a number of network devices such as access points (APs) that can support communication for a number of wireless devices. A wireless device may communicate with a network device bidirectionally. For example, in a wireless local area network (WLAN), a station (STA) may communicate with an associated AP via downlink and uplink. The downlink (or forward link) refers to the communication link from the AP to the station, and the uplink (or reverse link) refers to the communication link from the STA to the AP.

In WLANs, there may be cases in which multiple STAs are in communication with a particular AP. Access to the wireless medium may be controlled through a medium access control (MAC), which may allow different STAs to access a wireless channel according to predefined rules associated with the wireless network such as, for example, according to the IEEE 802.11 protocol. When a station desires to establish a connection with a wireless network, the station may initiate what is referred to as an active scan, in which the station transmits a probe request. Any AP that receives the probe request may respond to the probe request with a probe response. The probe response(s) may include information related to the sending AP(s), and may be used to initiate the establishment of a connection between the station and an AP.

In situations where there are a large number of stations seeking to establish connections with an AP, a large number of probe requests may be received by AP(s), and transmission of related probe responses may consume a significant amount of wireless resources. In order to enhance utilization of the wireless network, it may be desirable to implement techniques with reduced overhead associated with active scan operations.

### SUMMARY

Various methods, systems, devices, and apparatuses are described for enhanced network utilization in a wireless communications network through efficient transmissions of active scan information between an access point (AP) and a station. An AP may receive a number of different probe requests from a number of different stations in the wireless communications network. The AP may group probe responses and provide a single probe response to the stations in response to multiple probe requests. The single probe response may be a broadcast probe response that may be received by a number of stations, or may be a unicast probe response for a particular station. A data rate of the probe response may be determined based on a signal strength of the received probe request(s).

A station may transmit probe request(s) to discover access points, with the probe request(s) indicating that the station is capable of receiving a broadcast probe response. In response to the probe request(s), the station may receive a broadcast probe response that is transmitted by an AP and the broadcast probe response may be received at multiple stations. Information from the probe response may be used to initiate establishment of a connection between the station and AP.

A method for wireless communications by an access point in a wireless communications network may include receiving multiple probe requests from one or more stations; determining characteristics of the multiple probe requests; and transmitting a single probe response to at least two of the multiple probe requests based at least in part on the characteristics of the multiple probe requests. Determining the characteristics of the multiple probe requests may include determining that the multiple probe requests are received from a first station, and transmitting the single probe response may include transmitting the single probe response to the first station. The single probe response may be a unicast probe response to the first station. Determining the characteristics of the multiple probe requests may include determining that each of the multiple probe requests from the first station exceeds a probe request power threshold and the probe response may be transmitted at a data rate exceeding two megabits per second responsive to determining that each of the multiple probe requests exceeds the probe request power threshold.

Determining the characteristics of the multiple probe requests may include determining that the multiple probe requests are received from multiple different stations; and determining whether each of the multiple different stations is capable of receiving a broadcast probe response. Transmitting the single probe response may include transmitting a broadcast probe response to the multiple different stations responsive to determining that at least two of the multiple different stations are capable of receiving the broadcast probe response. Transmitting the single probe response may include transmitting a broadcast probe response to a first station and a second station of the multiple different stations responsive to determining that the first and second stations are capable of receiving the broadcast probe response; and the method may also include transmitting a unicast probe response to a third station of the multiple different stations responsive to determining that the third station is not capable of receiving the broadcast probe response.

Determining whether each of the multiple different stations is capable of receiving a broadcast probe response may include determining whether a broadcast probe response flag is present in the probe request from each of the multiple different stations. Additionally or alternatively, determining whether each of the multiple different stations is capable of receiving a broadcast probe response may include determining whether a signal of another advanced capability that implies a station is capable of receiving the broadcast probe response is present in the probe request of each of the multiple different stations. Additionally or alternatively, determining the characteristics of the multiple probe requests may include determining that the multiple probe requests exceed a probe request power threshold, and transmitting the single probe response may include transmitting a broadcast probe response at a data rate exceeding two megabits per second responsive to determining that the multiple probe requests exceed the probe request power threshold.

A method for wireless communications may include receiving at least one probe request from a station; determining characteristics of the at least one probe request; and transmitting a probe response having a transmit data rate based on the characteristics of the at least one probe request. Determining the characteristics of the at least one probe request may include determining whether a first probe request received power exceeds a probe request power threshold. If the first probe request received power exceeds the probe request power threshold, the probe response to the first station may be transmitted using orthogonal frequency division multiplexing (OFDM). In some examples, the probe response to the station may be transmitted at a data rate exceeding two megabits per second responsive to determining that the first probe request received power exceeds the probe request power threshold. Additionally or alternatively, the probe response to the station may be transmitted at a data rate of less than two megabits per second responsive to determining that the first probe request received power is below the probe request power threshold.

Determining the characteristics of the at least one probe request may include determining that a plurality of probe requests are received. Transmitting the probe response may include transmitting a single probe response responsive to the plurality of probe requests. The plurality of probe requests may be received from a station, and the single probe response may include a unicast probe response transmitted to the station. The single probe response may be transmitted at a data rate exceeding two megabits per second when each of the plurality of probe requests is received at a power that exceeds a probe request power threshold. The plurality of probe requests may be received from a plurality of stations, and the single probe response may include a broadcast probe response transmitted to the plurality of stations. The broadcast probe response may be transmitted at a data rate exceeding two megabits per second when each of the plurality of probe requests is received at a power that exceeds a probe request power threshold.

A method for wireless communications may include transmitting a probe request to discover at least one access point, and receiving a broadcast probe response from an access point responsive to the probe request. Transmitting the probe request may include transmitting an indication of a capability to receive the broadcast probe response. The indication may include a broadcast probe response flag and/or a signal of another advanced capability that implies the station is capable of receiving the broadcast probe response. Receiving the broadcast probe response may include receiving the probe response using OFDM, and/or receiving the probe response at a data rate exceeding two megabits per second.

An apparatus for wireless communications by an access point in a wireless communications network may include a probe request monitor to receive multiple probe requests from at least one station; a request characteristic monitor to determine characteristics of the multiple probe requests; and a probe response manager to transmit a single probe response to at least two of the multiple probe requests based at least in part on the characteristics of the multiple probe requests. The apparatus may implement one or more aspects of the corresponding method described above.

An apparatus for wireless communications may include a probe request monitor to receive at least one probe request from a station; a request characteristic monitor to determine characteristics of the at least one probe request; and a probe response manager to transmit a probe response having a transmit data rate based on the characteristics of the at least one probe request. The apparatus may implement one or more aspects of the corresponding method described above.

An apparatus for wireless communications may include a probe request manager to transmit a probe request to discover at least one access point; and a probe response manager to receive a broadcast probe response from an access point responsive to the probe request. The apparatus may implement one or more aspects of the corresponding method described above.

An apparatus for wireless communications by an access point in a wireless communications network may include means for receiving multiple probe requests from at least one station; means for determining characteristics of the multiple probe requests; and means for transmitting a single probe response to at least two of the multiple probe requests based at least in part on the characteristics of the multiple probe requests. The apparatus may implement one or more aspects of the corresponding method described above.

An apparatus for wireless communications may include means for receiving at least one probe request from a station; means for determining characteristics of the at least one probe request; and means for transmitting a probe response having a transmit data rate based on the characteristics of the at least one probe request. The apparatus may implement one or more aspects of the corresponding method described above.

An apparatus for wireless communications may include means for transmitting a probe request to discover at least one access point; and means for receiving a broadcast probe response from an access point responsive to the probe request. The apparatus may implement one or more aspects of the corresponding method described above.

A computer program product for wireless communication in a wireless communications network may include a non-transitory computer-readable medium storing instructions executable by a processor to receive multiple probe requests from one or more stations; determine characteristics of the multiple probe requests; and transmit a single probe response to at least two of the multiple probe requests based at least in part on the characteristics of the multiple probe requests. The instructions may be configured to cause the processor to implement one or more aspects of the corresponding method described above.

A computer program product for wireless communication in a wireless communications network may include a non-transitory computer-readable medium storing instructions executable by a processor to receive at least one probe request from a station; determine characteristics of the at least one probe request; and transmit a probe response having a transmit data rate based on the characteristics of the at least one probe request. The instructions may be configured to cause the processor to implement one or more aspects of the corresponding method described above.

A computer program product for wireless communication in a wireless communications network may include a non-transitory computer-readable medium storing instructions executable by a processor to transmit a probe request to discover at least one access point; and receive a broadcast probe response from an access point responsive to the probe request. The instructions may be configured to cause the processor to implement one or more aspects of the corresponding method described above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram that illustrates an example of a wireless local area network (WLAN) that supports power conservation modes according to various examples;

FIG. 2 is a flowchart of operations related to active scan techniques according to various examples;

FIG. 3 is another flowchart of operations related to active scan techniques according to various examples;

FIG. 4 is a flowchart of operations related to active scan techniques according to various examples;

FIGS. 5A-5C show a block diagrams that illustrate examples of an architecture for active scan overhead reduction according to various examples;

FIG. 6 shows a block diagram that illustrates a station architecture according to various examples;

FIG. 7 shows a block diagram that illustrates an access point (AP) architecture according to various examples;

FIG. 8 is a flowchart of a method for probe response transmission in a wireless communication system according to various examples;

FIG. 9 is a flowchart of another method for probe response transmission in a wireless communication system according to various examples;

FIG. 10 is a flowchart of yet another method for probe response transmission in a wireless communication system according to various examples; and

FIG. 11 is a flowchart of a method for access point discovery by a wireless device in a wireless communication system according to various examples.

### DETAILED DESCRIPTION

Described examples are directed to methods, systems, devices, and apparatuses for accessing a wireless communications network that may reduce overhead associated with active scan techniques. The overhead reduction may be beneficial in many instances and may provide a larger percentage of wireless resources that may be used by data traffic rather than for active scan transmissions. Overhead from traditional active scan techniques may be increased in cases where a network is relatively crowded, with many stations seeking wireless connection establishment with a number of access points (APs). For example, in a full stadium or other venue with a high concentration of users, a relatively large number of access points may be deployed to provide wireless network connectivity. However, in these cases the effective wireless medium access time available for data transmissions may be reduced significantly due to the transmission of probe request and probe response frames associated with active scans from a number of stations. These probe frames are typically transmitted at the lowest data rate of 1 Megabits per second (Mbps), which can result in significant usage of available wireless resources.

Various methods, systems, devices, and apparatuses are described for enhanced network utilization in a wireless communications network through efficient transmissions of active scan information between an AP and a station. An AP may, according to various examples, receive a number of different probe requests from a number of different stations in the wireless communications network. The AP may group probe responses, according to some examples, and provide a single probe response to multiple probe requests. The single probe response that is a response to multiple probe requests may be a broadcast probe response that may be received by a number of stations, or may be a unicast probe response for a particular station.

In some examples, an AP may receive probe requests from multiple stations, and determine that the multiple stations that transmitted the requests are capable of receiving a broadcast probe response. In this case, a broadcast probe response may be transmitted, rather than a number of unicast probe responses, thereby reducing the amount of wireless resources consumed in responding to the probe requests. In cases where station(s) are not capable of receiving a broadcast probe response (e.g., legacy station implementations that filter received broadcast packets while scanning), an AP may transmit a unicast probe response to the particular station(s). In certain examples, an AP may determine if a broadcast probe response may be transmitted based on characteristics of the probe requests that indicate that the stations that transmitted the probe requests are capable of receiving a broadcast probe response, such as through a capability flag set in the probe request or an indication of a very high throughput (VHT) phase 2 capability, for example.

In some examples, overhead associated with active scan techniques may be reduced, additionally or alternatively, through transmission of probe responses at higher data rates. For example, if an AP receives probe requests that have received signal strengths above a threshold, probe response(s) may be transmitted having a data rate that is higher than the legacy data rate (e.g., 1 Mbps) for probe response frames. The increased data rate for the probe response may reduce the amount of wireless resources required for the probe response, and thereby enhance the efficiency of the wireless communications network. In certain examples, if probe requests have a received signal strength greater than a predetermined threshold, the probe response(s) are not transmitted using 1, 2, 5.5 or 11 Mbps data rates. This measure, in deployments operating according to certain wireless communication protocols, causes that probe response frames transmitted to nearby station(s) to be sent using orthogonal frequency division multiplexing (OFDM), which reduces transmission time and thereby frees more wireless resources for data transmissions. In other examples, if an AP detects a received signal strength greater than the threshold, a probe response is transmitted using a data rate greater than 2 Mbps, which reduces the transmit time and thereby reduces overhead associated with active scans.

The active scan techniques presented herein are generally described in connection with wireless local area networks (WLANs) for simplicity. A WLAN (or Wi-Fi network) may refer to a network that is based on the protocols described in the various IEEE 802.11 standards (e.g., 802.11a/g, 802.11n, 802.11ac, 802.11ah, etc.). The same or similar techniques, however, may be used for various other wireless communications systems such as cellular wireless systems, peer-to-peer wireless communications, ad hoc networks, satellite communications systems, and other systems. The terms “system” and “network” may be used interchangeably.

Thus, the following description provides examples, and is not limiting of the scope, applicability, or configuration set forth in the claims. Changes may be made in the function and arrangement of elements discussed without departing from the spirit and scope of the disclosure. Various examples may omit, substitute, or add various procedures or components as appropriate. For instance, the methods described may be performed in an order different from that described, and various steps may be added, omitted, or combined. Also, features described with respect to certain examples may be combined in other examples.

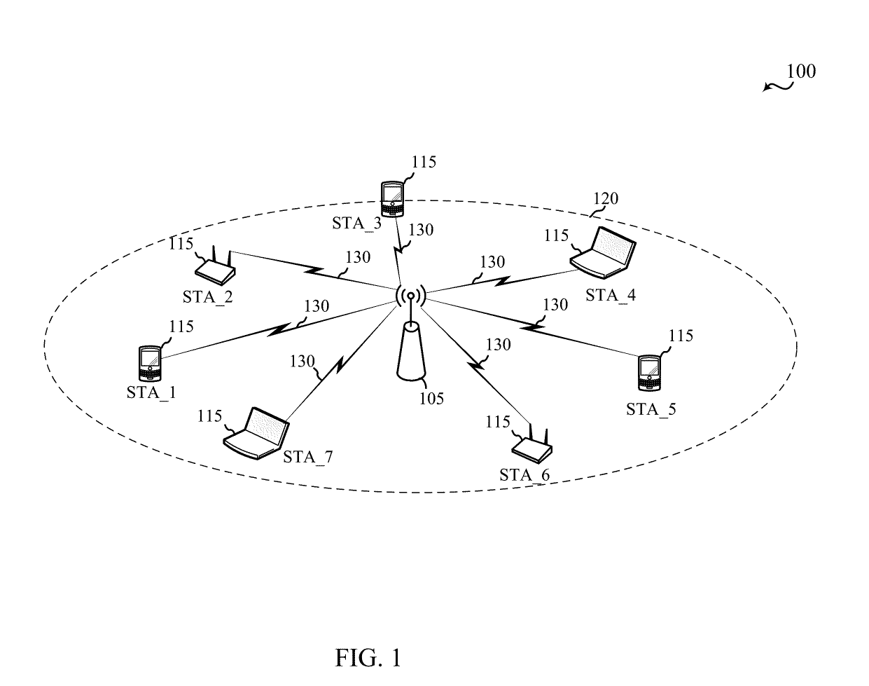

Referring first to FIG. 1, a WLAN 100 or Wi-Fi network is shown that is configured to provide enhanced network utilization. The WLAN 100 includes an AP 105 and multiple associated stations 115. In this example, there are shown seven (7) stations or STAs 115, which are identified as STA_1, STA_2, STA_3, STA_4, STA_5, STA_6, and STA_7. The WLAN 100, however, may have more or fewer stations 115 than those shown in FIG. 1 since the number shown is simply for illustrative purposes. The AP 105 and the associated stations 115 may represent a basic service set (BSS). The various stations 115 in the BSS are able to communicate with one another through the AP 105. Also shown is a coverage area 120 of the AP 105, which may represent a basic service area (BSA) of the WLAN 100. Although not shown in FIG. 1, the BSS associated with the WLAN 100 may be connected to a wired or wireless distribution system (DS) that allows multiple APs to be connected in an extended service set.

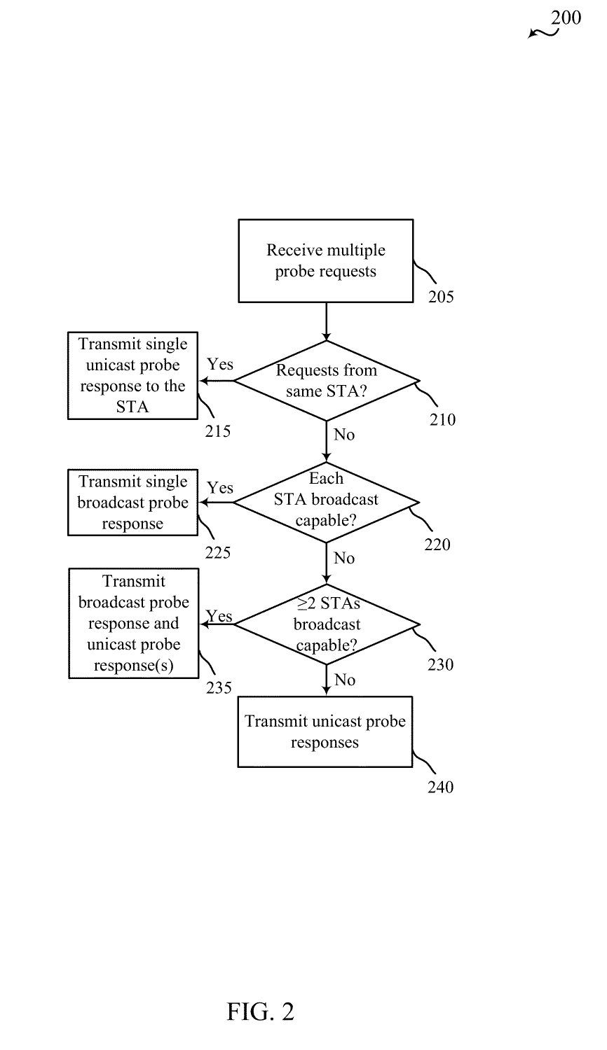

The AP 105 is configured to communicate bi-directionally with each of the stations 115 using transmissions 130. The transmissions 130 may include downlink transmissions (e.g., beacon frames) that are sent from the AP 105 to a station 115 as well as uplink transmissions that are sent from a station 115 to the AP 105. These transmissions may include active scan transmissions, in which a probe request may be transmitted by station(s) 115. AP 105 may receive the probe request and transmit a probe response frame in response to the probe request. According to legacy operation, a probe response frame may be transmitted for each received probe request. In situations in which a relatively dense and large amount of users desire access to the WLAN 100, the transmission of probe responses for each received probe request may consume a significant amount of available wireless resources, as mentioned above. According to some examples, AP 105 may receive a number of different probe requests from a number of different stations 115, and may group probe responses and/or transmit probe responses at a relatively high data rate, and may thereby reduce the amount of wireless resources consumed in responding to the probe requests. Various examples of a wireless communications system employing active scan techniques with reduced overhead will be described with respect to FIGS. 2-11.

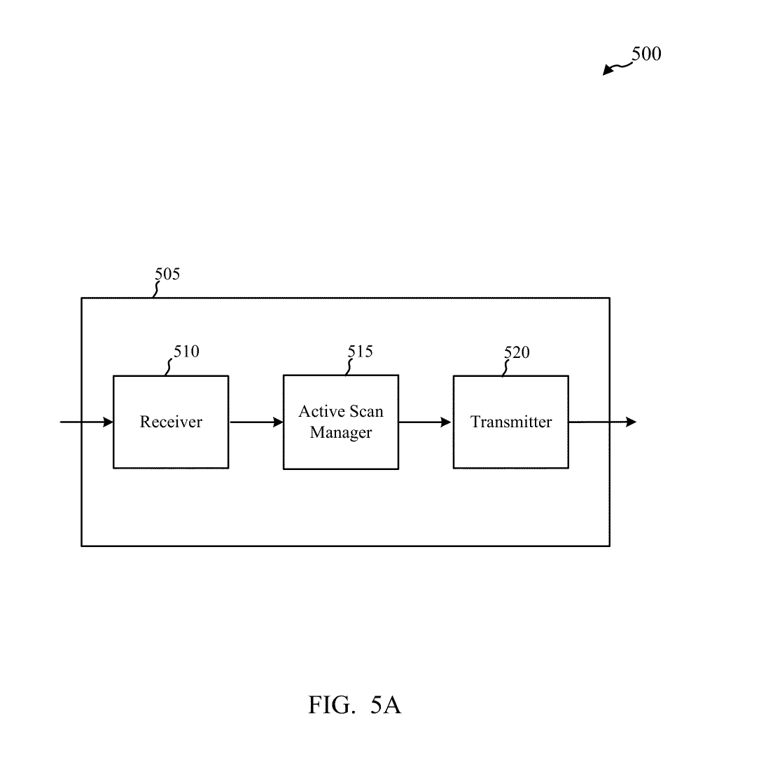

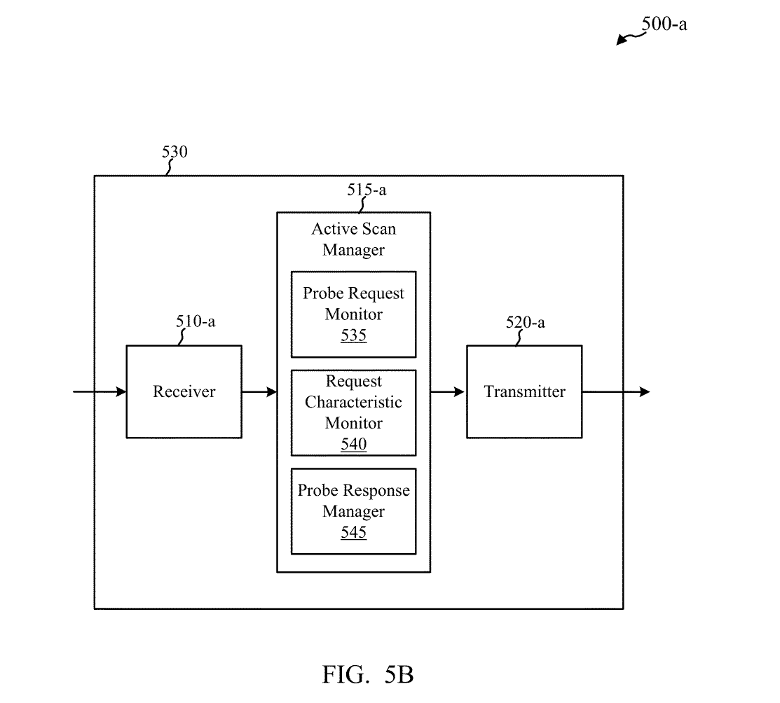

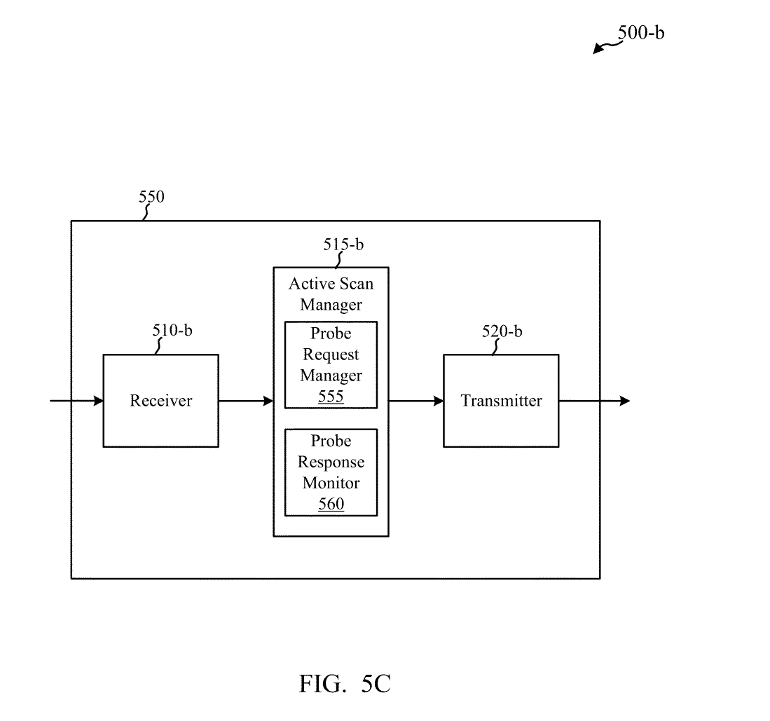

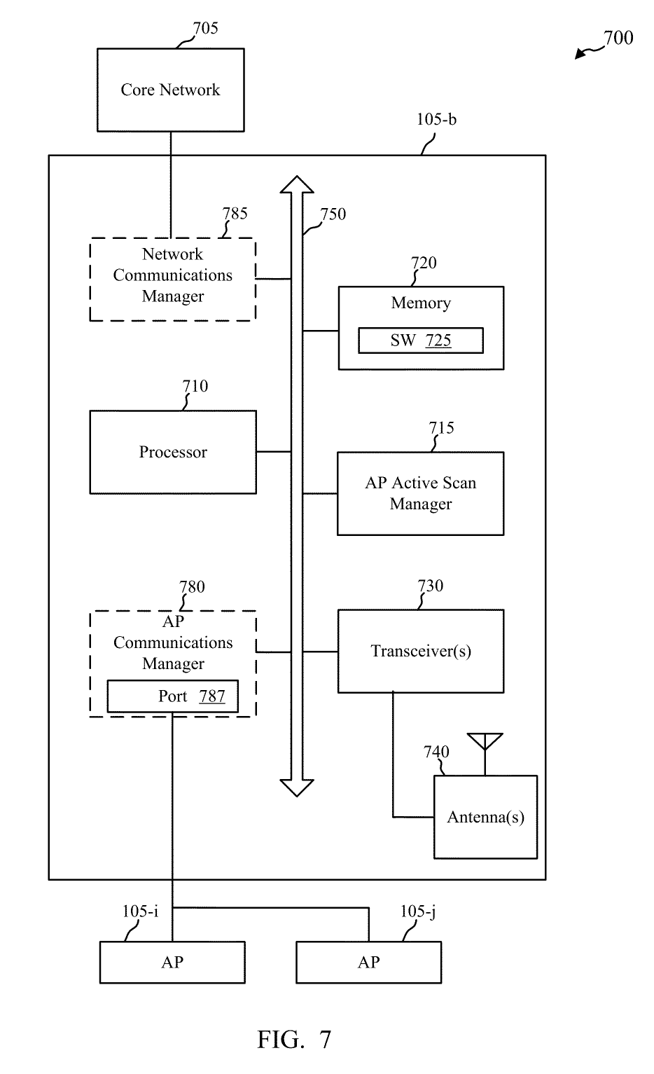

With reference now to FIG. 2, a flow diagram of a method 200 for transmitting probe responses in active scan techniques is discussed in accordance with various examples. The method 200 may be implemented using, for example, the AP 105 of FIG. 1, AP 105 of FIG. 7 and/or devices of FIG. 5A or 5B, discussed below. At block 205, the AP receives multiple probe requests. The AP may be, for example, one of multiple APs in a wireless network associated with a venue that has a high density of users. In these situations, the AP may receive a relatively large number of probe requests, and transmitting probe responses to each of the probe requests according to legacy active scan techniques may consume a relatively large amount of the wireless resources available to the AP. In the example of FIG. 2, overhead associated with active scan probe response transmissions may be reduced through grouping responses to multiple probe requests. The overhead reduction may be made, as will be discussed below, through a determination of characteristics of the probe requests, and transmission of a reduced number of probe requests based at least in part on the characteristics of the probe requests.

One characteristic of a probe request may be the identification of a station that transmitted the probe requests. At block 210, the AP of this example determines if the received probe requests are from the same station. If the probe requests are from the same station, a single unicast probe response may be transmitted to the station, as indicated at block 215. For example, a first station may transmit two probe requests, and the AP may transmit a single unicast probe response to the first station. The single probe response may be transmitted rather than multiple probe responses, and thus the overhead associated with active scan processes may be reduced. In some examples, a maximum probe response interval may be set, and a probe response may not be transmitted to the same station more often than once per probe response interval, and a single probe response may be transmitted when multiple probe requests have been received from the same station during this time period.

Another characteristic of a probe request may be an indication of whether the station transmitting the probe request is capable of receiving a broadcast, rather than unicast, probe responses. If it is determined at block 210 that the probe requests are not all from the same station, the AP may then determine if each station that transmitted a probe request is capable of receiving a broadcast probe response, as indicated at block 220. The determination may be made, in some examples, by identifying a broadcast response capability flag that may have been set in the received probe requests, that indicates the sending station is capable of receiving broadcast probe response frames.

In other examples, broadcast probe response capability of a station may be determined based on another advanced capability identified in the probe request. For example, a probe request indicating that a station has VHT phase 2 capability may be used to identify the station as having capability to receive a broadcast probe response. If it is determined at block 220 that each station is capable of receiving a broadcast probe response, a single broadcast probe response frame is transmitted, as indicated at block 225. By transmitting a broadcast probe response frame, overhead associated with transmitting multiple probe response frames to particular stations may be avoided, thus providing additional wireless resources that are available for data transmissions. In some examples, a broadcast probe response may be transmitted with a minimum broadcast probe response interval, and therefore broadcast probe response frames may be transmitted at response intervals.

If, at block 220, it is determined that each station transmitting a probe request is not capable of receiving a broadcast probe response, it is determined, at block 230, if multiple stations transmitting probe requests are capable of receiving broadcast probe response frames. If multiple stations are capable of receiving broadcast probe response frames, the AP may transmit a broadcast probe response frame, as well as unicast probe response frame(s), as indicated at block 235. For example, if an AP receives probe request frames from six stations, it may be determined that four of the stations are capable of receiving broadcast probe responses, while two of the stations are not capable of receiving broadcast probe responses. Thus, the AP in this situation may transmit one broadcast probe response, and two unicast probe responses, for a total of three probe response transmissions, rather than six probe responses that would be transmitted if each probe request were provided an individual response.

If it is determined at block 230 that two (or more) stations are not capable of receiving broadcast probe responses, the AP transmits unicast probe response frames to each of those stations, as indicated at block 240. Thus, according to the techniques of FIG. 2, the number of probe responses transmitted by an AP may be significantly reduced depending on the capability at stations to receive broadcast probe responses, thereby significantly reducing the overhead associated with active scan probe response frames, which allows additional wireless resources to be used for data transmissions with the AP, and may therefore provide for enhanced efficiency in the usage of the wireless resources.

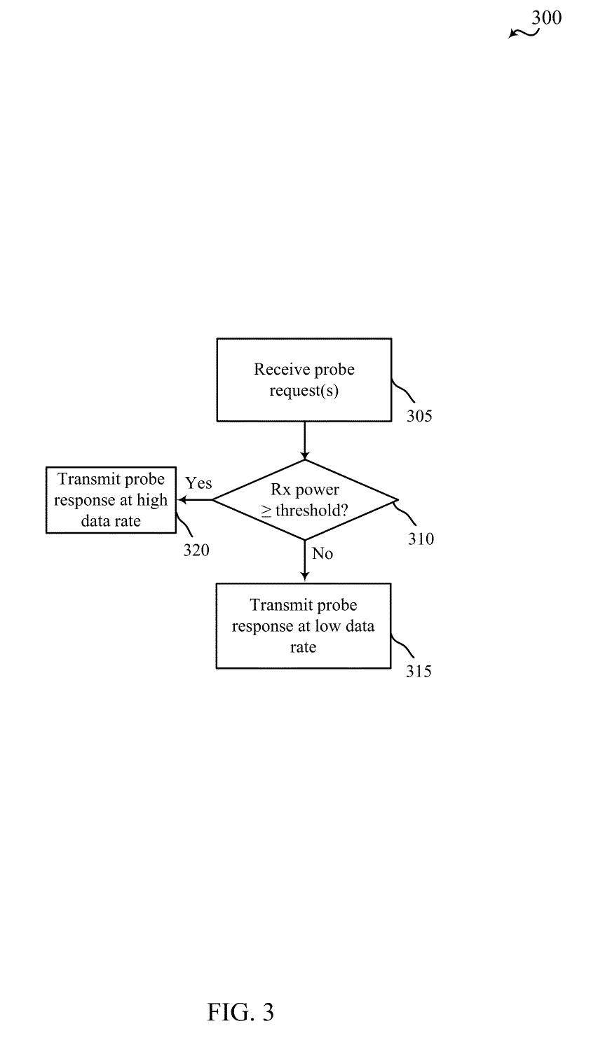

With reference now to FIG. 3, a flow diagram of a method 300 for transmitting probe responses in active scan techniques is discussed in accordance with various examples. The method 300 may be implemented using, for example, the AP 105 of FIG. 1, AP 105 of FIG. 7 and/or devices of FIG. 5A or 5B, discussed below. At block 305, the AP receives probe request(s). The AP may be, for example, one of multiple APs in a wireless network associated with a venue that has a high density of users. As discussed above, in these situations the AP may receive a relatively large number of probe requests, responses to which may consume a significant amount of available wireless resources of the AP. In the example of FIG. 3, overhead associated with active scan probe response transmissions may be reduced through transmission of probe responses at relatively high data rates. The overhead reduction may be made, as will be discussed below, through a determination of characteristics of the probe requests, and transmission of high data rate probe responses based at least in part on the characteristics of the probe requests.

In some examples, the characteristics of the probe requests may include a quality metric such as a power at which the probe requests are received at the AP. If probe requests are received at relatively high power, it may indicate that the station is relatively close to the AP and/or that channel conditions between the AP and station are relatively good. The received power of the probe request(s) may be measured according to any available technique for measuring received signal strength, such as received signal strength indicator (RSSI) or signal to interference and noise ratio (SINR), for example. In some examples, other metric(s) may indicate the quality of a wireless link may be utilized, either alone or in conjunction with other metric(s), such as packet delivery ratio (PDR) or bit error rate (BER) associated with a station, for example. In any event, a favorable channel quality may give high confidence that the station will be capable of receiving transmissions at a higher data rate than the legacy data rate of 1 Mbps for probe response frames.

In the example of FIG. 3, the AP may determine whether the received power of the probe request(s) is greater than a probe request power threshold, as indicated at block 310. If the received power is less than the probe request power threshold, the AP may transmit the probe response at a low data rate, as indicated at block 315. The low data rate may be, for example, 1 Mbps. If, at block 310, it is determined that the received power meets or exceeds the power threshold, the AP may transmit the probe response as a high data rate, as indicated at block 320. In some examples, the high data rate may be a data rate exceeding two Mbps, which reduces transmit time and thus reduces the amount of wireless resources consumed for the probe response transmission. In certain examples, the AP may select a data rate for transmission of the probe response to be a data rate that uses an orthogonal frequency division multiplexing (OFDM) transmission protocol. For example, if the probe request was received at a power higher than the received power threshold, the AP may determine that the probe response is not to be transmitted using 1, 2, 5.5 or 11 Mbps data rates, thus causing the probe response to be transmitted to the station using OFDM, which reduces the transmit time. In other examples, the AP may select an 802.11b data rate of 5.5 Mbps or 11 Mbps, which has the advantage that the probe response can also be received when the station is on an adjacent channel (i.e. which is not the same channel as the AP).

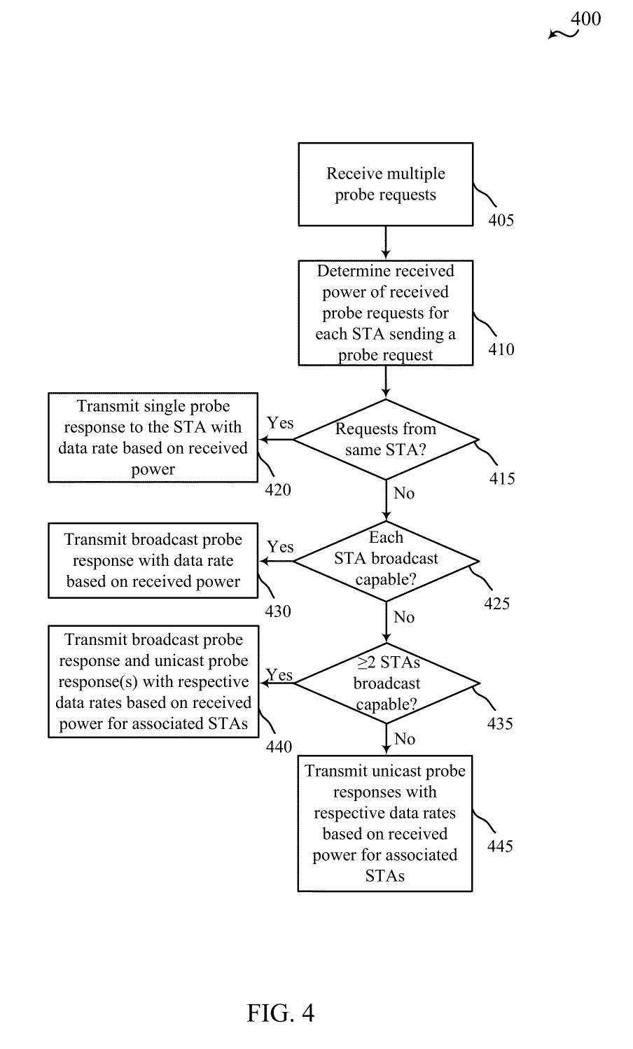

With reference now to FIG. 4, a flow diagram of a method 400 for transmitting probe responses in active scan techniques is discussed in accordance with various examples. The method 400 may be implemented using, for example, the AP 105 of FIG. 1, AP 105 of FIG. 7 and/or devices of FIG. 5A or 5B, discussed below. In this example, a combination of grouping of probe responses and transmission of probe responses at high data rates may be employed based on characteristics of multiple probe requests received at an AP. At block 405, the AP receives multiple probe requests. Similarly as discussed above, the AP may be one of multiple APs in a wireless network associated with a venue that has a high density of users, for example. In these situations the AP may receive a relatively large number of probe requests, responses to which may consume a significant amount of available wireless resources of the AP. In the example of FIG. 4, overhead associated with active scan probe response transmissions may be reduced through both grouping of probe responses and transmission of probe responses at relatively high data rates. The overhead reduction may be made, as will be discussed below, through a determination of characteristics of the probe requests, and transmission of high data rate probe responses and/or grouped probe responses based at least in part on the characteristics of the probe requests.

At block 410, the AP may determine a received power (or other channel quality metric) associated with received probe request(s) for each station sending a probe request. At block 415, the AP determines whether each of the requests is from the same station. In the event that all the probe requests are from the same station, the AP transmits single probe response to the station with data rate based on received power, as indicated at block 420. Similarly as discussed above with respect to FIG. 3, the data rate may be increased in situations where the received power, or other channel quality metric, to a data rate that is higher than legacy probe response data rates, or that uses OFDM for transmission of the probe response frame, for example.

If it is determined at block 415 that the probe requests come from more than one station, the AP may determine if each station from which the probe requests have been received is capable of receiving a broadcast probe response, as indicated at block 425. The determination may be made by evaluating, for example, a flag that may be set in the probe requests or the indication of an advanced capability in the probe requests that indicates that the station that transmitted the probe request is capable of receiving a broadcast probe response, similarly as discussed above. If each station that sent a probe request is capable of receiving a broadcast probe response, the AP may transmit a broadcast probe response with a data rate based on received power, or other channel quality metric, of the probe requests. For example, if all of the probe requests are received at a power that exceeds a threshold value, the broadcast probe response may be transmitted at a high data rate and/or at a data rate that allows for OFDM transmission of the probe response frame. If some of the probe requests have a received power in excess of the threshold, but some have a received power below the threshold, the probe response may be transmitted at a lower data rate, such as 1 Mbps, in order to provide higher likelihood of a successful reception of the probe response at stations having lower channel quality.

If, at block 425, it is determined that each station from which a probe request is received is not capable of receiving a broadcast probe response, it is determined, at block 435, whether probe requests have been received from two (or more) stations that are capable of receiving a broadcast probe response. If probe requests are received from multiple stations that are capable of receiving a broadcast probe response, the AP may transmit, at block 440, a broadcast probe response and unicast probe response(s) with respective data rates based on received power for the associated stations. The broadcast probe response may be transmitted for reception by the stations that are capable of receiving the responses, and may have a data rate that is determined based on a received power of the probe requests associated with these stations, for example. The unicast probe response(s) may be transmitted to stations that are not capable of receiving a broadcast probe response, and may also have a data rate that is determined based on a received power of the probe requests associated with these stations, for example.

If, at block 435, it is determined that multiple probe requests have not been received from multiple stations that are capable of receiving a broadcast probe response, the AP may transmit unicast probe responses to each station, with respective data rates based on received power for the associated station. For example, if one probe request is received from a station that is capable of receiving a broadcast probe response, but two other probe requests are received from stations that are not capable of receiving a broadcast probe response, the AP may transmit unicast probe responses to each of the three stations. In some examples, the AP may still transmit a broadcast probe response, as well as two unicast probe responses, in order to potentially have the broadcast probe response received by other station(s) that are capable of receiving a broadcast probe response, but from which a probe request had not yet been received. Similarly as discussed above, a data rate for each of the responses may be determined by a channel quality metric, such as a received signal strength of the probe request for the associated station. Thus, method 400 provides an example for reducing overhead associated with active scan techniques by providing probe responses that are responsive to multiple probe requests, by providing probe responses having a data rate that is increased relative to a legacy data rate for probe responses, or a combination thereof

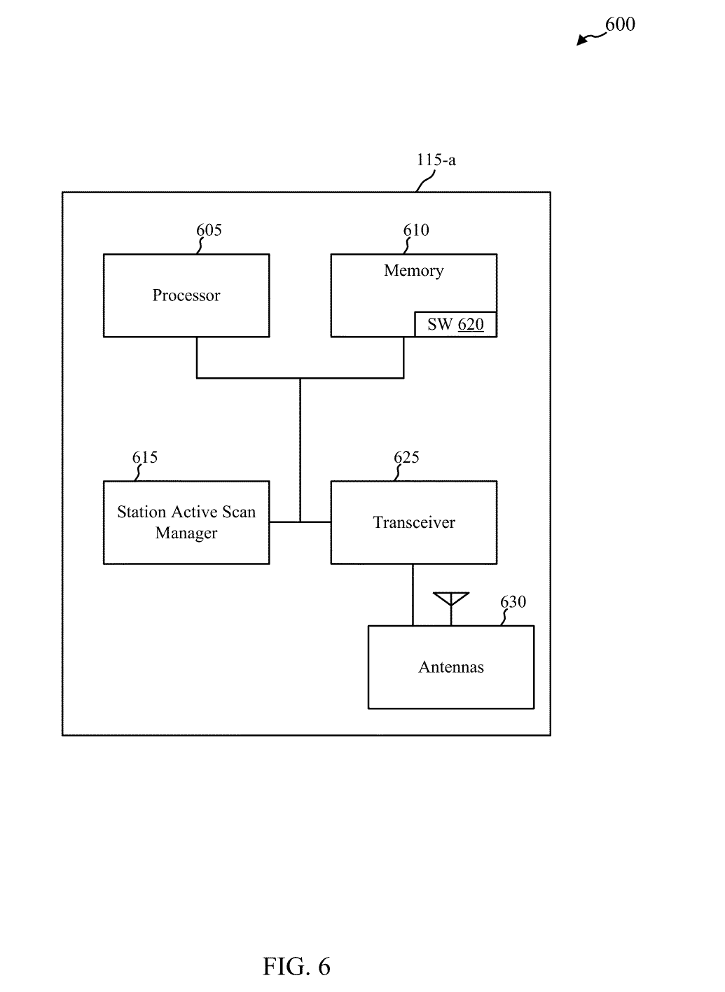

With reference now to FIG. 5A, a block diagram 500 illustrates a device 505 that may be used in a wireless communications system employing active scan techniques of various examples. The device 505 may be an example of aspects of the APs 105 or stations 115 described with reference to FIG. 1, and/or FIGS. 6-7 as will be described below. The device 505, or portions of it, may also be a processor. The device 505 may include a receiver 510, an active scan manager 515, and/or a transmitter 520. Each of these components may be in communication with each other. The device 505, through the receiver 510, the active scan manager 515, and/or the transmitter 520, may be configured to perform active scan operations for sending and/or receiving probe requests or probe responses with reduced overhead, similarly as discussed above with respect to FIGS. 1-4. For example, active scan manager 515 may determine if a probe response may be grouped, and/or may determine a transmit data rate for a probe response based on a characteristic of received probe requests, according to techniques such as described above.

With reference now to FIG. 5B, a block diagram 500-a illustrates a device 530 that may be used for active scan of various examples. The device 530 may be an example of aspects of the APs 105 described with reference to FIG. 1, and/or FIG. 7 as will be described below. The device 530, or portions of it, may also be a processor. The device 530 may include a receiver 510-a, an active scan manager 515-a, and/or a transmitter 520-a. similarly as described with respect to FIG. 5A. Each of these components may be in communication with each other. The active scan manager 515-a, in this example, includes a probe request monitor 535 that may monitor probe requests received at the device 530. Characteristic of the probe requests may be determined by request characteristic monitor 540 according to the techniques described above. The request characteristic monitor 540 may, for example, determine channel quality characteristics associated with received probe requests, may determine an identity of a station transmitting probe requests, and/or may determine if a station transmitting a particular probe request is capable of receiving a broadcast probe response. The channel quality characteristics may be provided to probe response manager 545, which may determine if probe responses are to be transmitted, whether any of the probe responses should be a broadcast probe response, and/or a transmit data rate for the probe responses, according to techniques described above with respect to FIGS. 1-4.

With reference now to FIG. 5C, a block diagram 500-b illustrates a device 550 that may be used for active scan of various examples. The device 550 may be an example of aspects of the stations 115 described with reference to FIG. 1, and/or FIG. 6 as will be described below. The device 550, or portions of it, may also be a processor. The device 550 may include a receiver 510-b, an active scan manager 515-b, and/or a transmitter 520-b. similarly as described with respect to FIG. 5A. Each of these components may be in communication with each other. The active scan manager 515-b, in this example, includes a probe request manager 555 that may determine to transmit probe requests and may provide indications of capabilities of the device 550, such as capability to receive a broadcast probe response, and/or other advanced capabilities of device 550, similarly as discussed above with respect to FIGS. 1-4. A probe response monitor 560 may monitor for received probe responses from AP(s), and upon receipt of a probe request may initiate a connection establishment procedure to establish a connection with an AP that transmitted the probe response, similarly as discussed above.

Turning to FIG. 6, a diagram 600 is shown that illustrates a station 115-a configured for active scanning according to various examples. The station 115-a may have various other configurations and may be included or be part of a personal computer (e.g., laptop computer, netbook computer, tablet computer, etc.), a cellular telephone, a smart phone, a PDA, a digital video recorder (DVR), an internet appliance, a gaming console, an e-readers, etc. The station 115-a may have an internal power supply (not shown), such as a small battery, to facilitate mobile operation. The station 115-a may be an example of the stations 115 of FIG. 1, and may implement various operations described with respect to FIGS. 1-4.

The station 115-a may include a processor 605, a memory 610, a transceiver 625, antennas 630, and a station active scan manager 615. The station active scan manager 615 may be an example of the active scan manager 515 of FIGS. 5A and/or 5C. Each of these components may be in communication with each other, directly or indirectly, over buses for example.

The memory 610 may include random access memory (RAM) and read-only memory (ROM). The memory 610 may store computer-readable, computer-executable software (SW) code 620 containing instructions that are configured to, when executed, cause the processor 605 to perform various functions described herein for active scan techniques. Alternatively, the software code 620 may not be directly executable by the processor 605 but be configured to cause the computer (e.g., when compiled and executed) to perform functions described herein.

The processor 605 may include an intelligent hardware device, e.g., a central processing unit (CPU), a microcontroller, an application-specific integrated circuit (ASIC), etc. The processor 605 may process information received through the transceiver 625 and/or to be sent to the transceiver 625 for transmission through the antennas 630. The processor 605 may handle, alone or in connection with the station active scan manager 615, various aspects for transmitting probe requests and receiving probe responses according to active scan techniques, as described herein.

The transceiver 625 may be configured to communicate bi-directionally with APs 105 in FIG. 1, and/or other wireless network nodes. The transceiver 625 may be implemented as one or more transmitters and one or more separate receivers. The transceiver 625 may include a modem configured to modulate packets and provide the modulated packets to the antennas 630 for transmission, and to demodulate packets received from the antennas 630. While the station 115-a may include a single antenna, there may be examples in which the station 115-a may include multiple antennas 630.

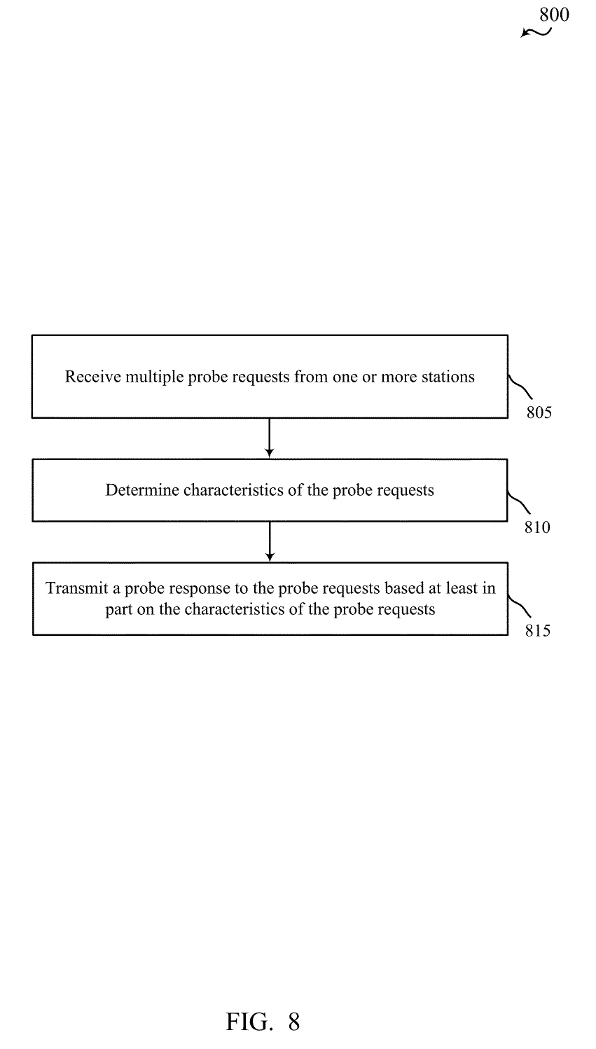

The components of the station 115-a may be configured to implement aspects discussed above with respect to FIGS. 1-5, and those aspects may not be repeated here for the sake of brevity. Moreover, the components of the station 115-a may be configured to implement aspects discussed below with respect to FIGS. 8-11, and those aspects may not be repeated here also for the sake of brevity.

Turning to FIG. 7, a diagram 700 is shown that illustrates an access point or AP 105-a configured for receiving probe request and transmitting probe responses according to various examples. In some examples, the AP 105-a may be an example of the APs 105 of FIG. 1. The AP 105-a may include a processor 710, a memory 720, a transceiver 730, antennas 740, and an AP active scan manager 715. The AP active scan manager 715 may be an example of the active scan manager 515 of FIGS. 5A and/or 5B. In some examples, the AP 105-a may also include one or both of an AP communications manager 780 and a network communications manager 785. Each of these components may be in communication with each other, directly or indirectly, over one or more buses 750.

The memory 720 may include RAM and ROM. The memory 720 may also store computer-readable, computer-executable software (SW) code 725 containing instructions that are configured to, when executed, cause the processor 710 to perform various functions described herein for probe request reception, determination of probe request characteristics, and probe response transmission. Alternatively, the software code 725 may not be directly executable by the processor 710 but be configured to cause the computer, e.g., when compiled and executed, to perform functions described herein.

The processor 710 may include an intelligent hardware device, e.g., a CPU, a microcontroller, an ASIC, etc. The processor 710 may process information received through the transceiver(s) 730, the AP communications manager 780, and/or the network communications manager 785. The processor 710 may also process information to be sent to the transceiver(s) 730 for transmission through the antenna(s) 740, to the AP communications manager 780, and/or to the network communications manager 785. The processor 710 may handle, alone or in connection with other components, various aspects related to probe request reception, processing and probe response transmission, as discussed above.

The transceiver(s) 730 may include a modem configured to modulate packets and provide the modulated packets to the antennas 740 for transmission, and to demodulate packets received from the antennas 740. The transceiver(s) 730 may be implemented as one or more transmitter(s) and one or more separate receiver(s). The transceiver(s) 730 may be configured to communicate bi-directionally, via the antenna(s) 740, with station(s) 115 as illustrated in FIG. 1, for example. The AP 105-a may include multiple antennas 740 (e.g., an antenna array). The AP 105-a may communicate with a core network 705 through the network communications manager 785. The AP 105-a may communicate with other APs, such as the AP 105-i and the AP 105-j, using an AP communications manager 780 through a port 787. The components of the AP 105-a may be configured to implement aspects discussed above with respect to FIGS. 1-5, and those aspects may not be repeated here for the sake of brevity. Moreover, the components of the AP 105-a may be configured to implement aspects discussed below with respect to FIGS. 8-11 and those aspects may not be repeated here also for the sake of brevity.

Turning next to FIG. 8, a flowchart is described for a method 800 for active scan probe response in accordance with various examples. The method 800 may be implemented using, for example, the APs 105 of FIGS. 1 and/or 7, and/or devices 505 and/or 530 of FIG. 5A and/or 5B, for example. At block 805, the AP may receive multiple probe requests from station(s) in the wireless communications network. For example, probe requests may be received from multiple stations, or multiple probe requests from a same station may be received. At block 810, the AP may determine characteristics of the multiple probe requests. These characteristics may include, for example, channel quality characteristics associated with received probe requests, an identity of a station transmitting each probe request, and/or if a station transmitting a particular probe request is capable of receiving a broadcast probe response, similarly as discussed above. At block 815, the AP may transmit a probe response to at least two of the multiple probe requests based at least in part on the characteristics of the multiple probe requests. For example, the AP may transmit a single probe response to a station that has sent two probe requests, and/or the AP may transmit a broadcast probe response to multiple stations that are capable of receiving a broadcast probe response.

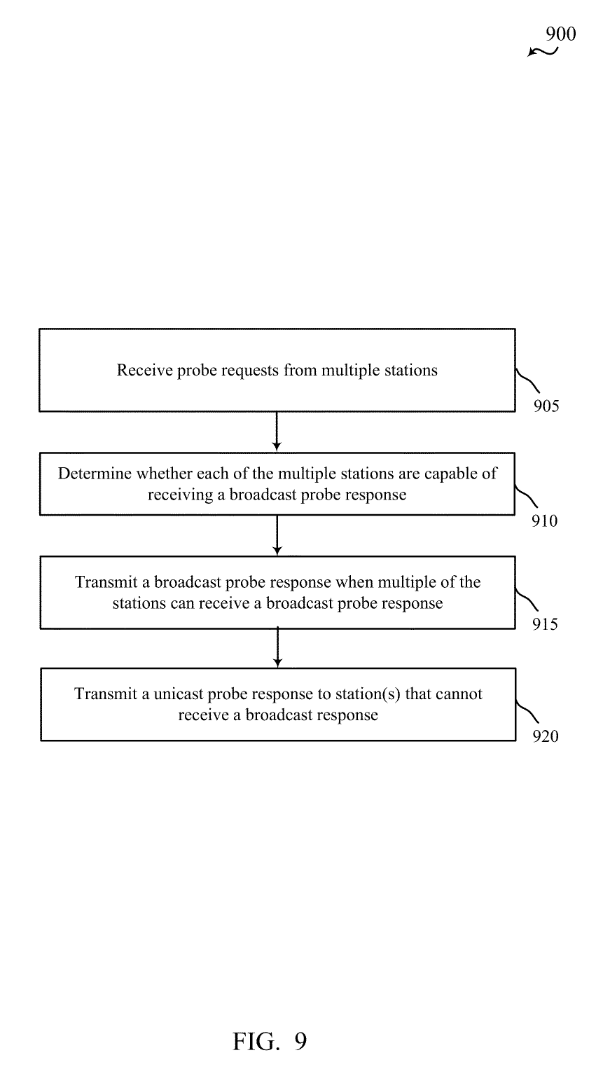

Turning next to FIG. 9, another flowchart is described for a method 900 for active scan probe response in accordance with various examples. The method 900 may be implemented using, for example, the APs 105 of FIGS. 1 and/or 7, and/or devices 505 and/or 530 of FIGS. 5A and/or 5B, for example. At block 905, the AP may receive probe requests from multiple stations. For example, probe requests may be received from multiple stations seeking to establish a connection in a wireless communication network. At block 910, the AP may determine whether each of the multiple stations is capable of receiving a broadcast probe response. The determination may be made by identifying a flag set in a probe request, or by identifying an advanced capability indicated in the probe request that indicates the capability to receive a broadcast probe response, for example. At block 915, the AP may transmit a broadcast probe response when at least two of the stations can receive a broadcast probe response. At block 920, the AP may, if necessary, transmit a unicast probe response to station(s) that cannot receive a broadcast response.

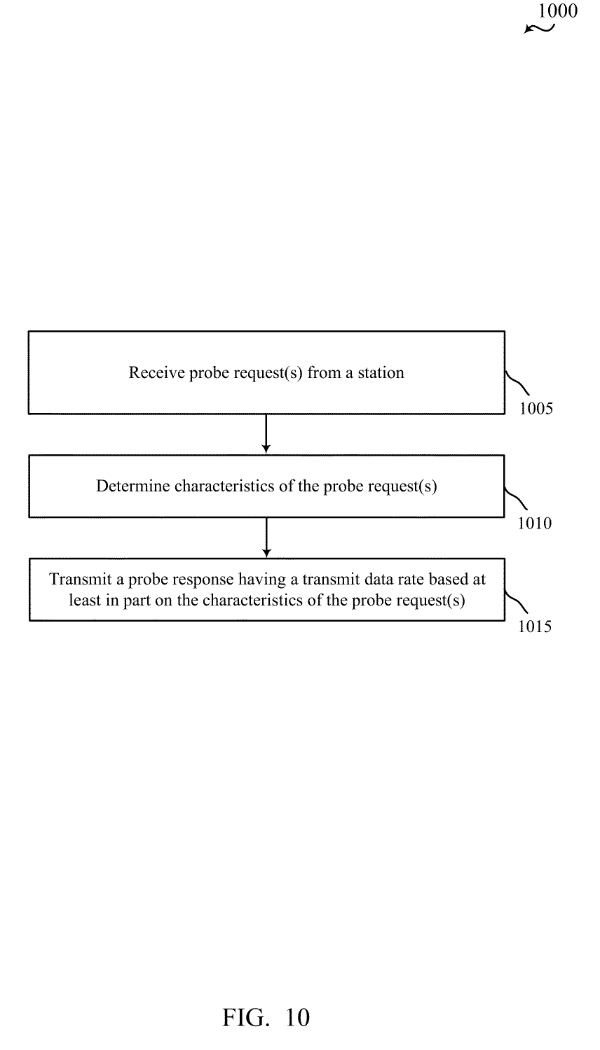

Turning next to FIG. 10, a flowchart is described for a method 1000 for active scan probe response in accordance with various examples. The method 1000 may be implemented using, for example, APs 105 of FIGS. 1 and/or 7, and/or devices 505 and/or 530 of FIGS. 5A and/or 5B, for example. At block 1005, an AP receives probe requests from a station. At block 1010, the AP may determine characteristics of the probe requests. The characteristics may include, for example, channel quality characteristics associated with received probe requests, such as an RSSI or SINR characteristic, similarly as discussed above. At block 1015, the AP may transmit a probe response having a transmit data rate based at least in part on the characteristics of the probe requests. In some examples, the AP may transmit a probe response having a transmit data rate of greater than 2 Mbps when the characteristics indicate a channel quality is above a certain threshold. Additionally or alternatively, the AP may select a data rate that provides data transmission according to a particular protocol that has a relatively low transmit duration, such as OFDM.

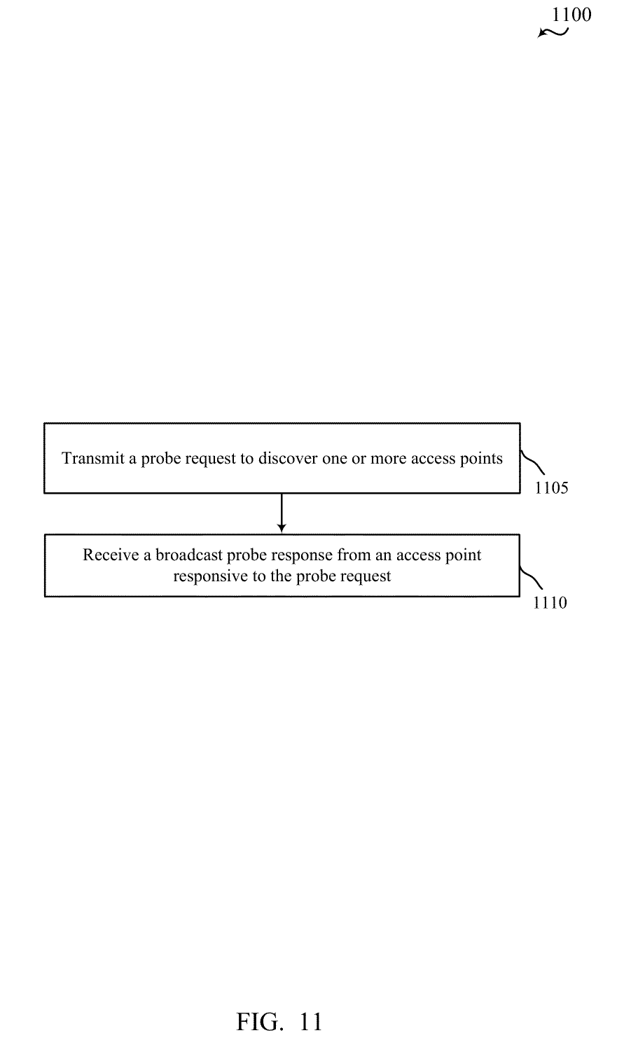

Turning next to FIG. 11, a flowchart is described for a method 1100 for active scan probe operations in accordance with various examples. The method 1100 may be implemented using, for example, the stations 115 of FIGS. 1 and/or 6, and/or devices 505 and/or 550 of FIGS. 5A and/or 5C, for example. At block 1105, a station may transmit a probe request to discover AP(s). The probe request may include, in some examples, an indicator that indicated the station is capable of receiving a broadcast probe response. The indication may be, for example, a broadcast probe response flag within the probe request, or may be in indication that the station is capable advanced operation(s) (e.g., VHT phase 2 capability). At block 1110, the station may receive a broadcast probe response from an access point responsive to the probe request. The broadcast probe response may be transmitted to other stations that are also capable of receiving a broadcast probe response, in various examples. In some examples, the broadcast probe response may be received that has a data transmission rate that is higher than a legacy data transmission rate for a probe response, similarly as discussed above.

The detailed description set forth above in connection with the appended drawings describes exemplary examples and does not represent the only examples that may be implemented or that are within the scope of the claims. The term “example” or “exemplary” when used in this description means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor or multiple microprocessors, in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable ROM (EEPROM), compact disk-ROM (CD-ROM) or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communications by an access point in a wireless communications network, comprising:
receiving multiple probe requests from at least one station;
determining characteristics of the multiple probe requests; and
transmitting a single probe response in response to at least two of the multiple probe requests based at least in part on the characteristics of the multiple probe requests.

2. The method of claim 1, wherein,
determining the characteristics of the multiple probe requests comprises determining that the multiple probe requests are received from a first station; and
transmitting the single probe response comprises transmitting the single probe response to the first station.

3. The method of claim 2, wherein the single probe response is a unicast probe response to the first station.

4. The method of claim 2, wherein,
determining the characteristics of the multiple probe requests comprises determining that each of the multiple probe requests from the first station exceeds a probe request power threshold; and
transmitting the single probe response to the first station comprises transmitting the single probe response at a data rate exceeding two megabits per second responsive to determining that each of the multiple probe requests from the first station exceeds the probe request power threshold.

5. The method of claim 1, wherein determining the characteristics of the multiple probe requests comprises:
determining that the multiple probe requests are received from multiple different stations; and
determining whether each of the multiple different stations is capable of receiving a broadcast probe response.

6. The method of claim 5, wherein transmitting the single probe response comprises:
transmitting a broadcast probe response to the multiple different stations responsive to determining that at least two of the multiple different stations are capable of receiving the broadcast probe response.

7. The method of claim 5, wherein transmitting the single probe response comprises:
transmitting a broadcast probe response to a first station and a second station of the multiple different stations responsive to determining that the first station and the second station are capable of receiving the broadcast probe response; and
wherein the method further comprises transmitting a unicast probe response to a third station of the multiple different stations responsive to determining that the third station is not capable of receiving the broadcast probe response.

8. The method of claim 5, wherein determining whether each of the multiple different stations is capable of receiving a broadcast probe response comprises:
determining whether a broadcast probe response flag is present in a probe request from each of the multiple different stations.

9. The method of claim 5, wherein determining whether each of the multiple different stations is capable of receiving a broadcast probe response comprises:
determining whether a signal of another advanced capability that implies a station is capable of receiving the broadcast probe response is present in a probe request of each of the multiple different stations.

10. The method of claim 5, wherein:
determining the characteristics of the multiple probe requests comprises determining that the multiple probe requests exceed a probe request power threshold; and
transmitting the single probe response comprises transmitting a broadcast probe response at a data rate exceeding two megabits per second responsive to determining that the multiple probe requests exceed the probe request power threshold.

11. A method for wireless communications, comprising:
receiving at least one probe request from a station;
determining characteristics of the at least one probe request; and
transmitting a probe response having a transmit data rate based on the characteristics of the at least one probe request.

12. The method of claim 11, wherein determining the characteristics of the at least one probe request comprises:
determining whether a first probe request received power exceeds a probe request power threshold.

13. The method of claim 12, wherein transmitting the probe response comprises:
transmitting the probe response to the station using orthogonal frequency division multiplexing (OFDM) responsive to determining that the first probe request received power exceeds the probe request power threshold.

14. The method of claim 12, wherein transmitting the probe response comprises:
transmitting the probe response to the station at a data rate exceeding two megabits per second responsive to determining that the first probe request received power exceeds the probe request power threshold.

15. The method of claim 12, wherein transmitting the probe response comprises:
transmitting the probe response to the station at a data rate of less than two megabits per second responsive to determining that the first probe request received power is below the probe request power threshold.

16. The method of claim 11, wherein determining the characteristics of the at least one probe request comprises:
determining that a plurality of probe requests are received.

17. An apparatus for wireless communications by an access point in a wireless communications network, comprising:
a probe request monitor to receive multiple probe requests from at least one station;
a request characteristic monitor to determine characteristics of the multiple probe requests; and
a probe response manager to transmit a single probe response to at least two of the multiple probe requests based at least in part on the characteristics of the multiple probe requests.

18. The apparatus of claim 17, wherein:
the request characteristic monitor is to determine that the multiple probe requests are received from a first station, and
the probe response manager is to transmit a unicast probe response to the first station.

19. The apparatus of claim 18, wherein:
the request characteristic monitor is to determine that each of the multiple probe requests from the first station exceeds a probe request power threshold; and
the probe response manager is to transmit the unicast probe response at a data rate exceeding two megabits per second responsive to the determination that each of the multiple probe requests exceeds the probe request power threshold.

20. The apparatus of claim 17, wherein the request characteristic monitor is further to:
determine that the multiple probe requests are received from multiple different stations; and
determine whether each of the multiple different stations is capable of receiving a broadcast probe response.
